(19) United States
(12) Patent Application Publication
(10) Pub. No.: US 2022/0355422 A1
(43) Pub. Date: Nov. 10, 2022

(54) LEAD-FREE SOLDER MATERIAL, LAYER STRUCTURE, METHOD OF FORMING A SOLDER MATERIAL, AND METHOD OF FORMING A LAYER STRUCTURE

(71) Applicant: Infineon Technologies AG, Neubiberg (DE)

(72) Inventors: Alexander ROTH, Zeitlarn (DE); Catharina WILLE, Regensburg (DE); Alexander HEINRICH, Bad Abbach (DE)

(73) Assignee: Infineon Technologies AG, Neubiberg (DE)

(21) Appl. No.: 17/713,857

(22) Filed: Apr. 5, 2022

(30) Foreign Application Priority Data
Apr. 22, 2021 (DE) 10 2021 110 298.7

(51) Int. Cl. B23K 35/36; B32B 15/01; B23K 35/02; B23K 1/00

(52) U.S. Cl. CPC B23K 35/3618; B32B 15/01; B23K 35/025; B23K 35/3615; B23K 1/00

(57) ABSTRACT

A lead-free solder material is provided. In one example, the solder material may include solder particles including at least 30 wt % nickel, and an activator including or consisting of at least one of a group of activator materials, the group including an organic acid or salt thereof, and an amine or salt thereof.

### CROSS-REFERENCE TO RELATED APPLICATION

This Utility Patent Application claims priority to German Patent Application No. 10 2021 110 298.7, filed Apr. 22, 2021, which is incorporated herein by reference.

### TECHNICAL FIELD

Various embodiments relate generally to a lead-free solder material, a layer structure, a method of forming a solder material, and to a method of forming a layer structure.

### BACKGROUND

For many applications, dies and clips are today soldered with a high lead (Pb) based soft solder paste. Since, however, an EU-wide ban of lead is under way (see, e.g., RoHS, ELV rules), an alternative die- and clip-attach system may need to be developed to be as least as good as the paste system based on a high lead content.

Solder pastes are bonding materials prepared by dispersing a solder powder (e.g., metal particles) in a flux. Solder pastes are typically, for example, applied to a printed circuit board by screen printing using a stencil, or to any metalized surface by dispensing through a syringe, so as to deposit a suitable small amount of the paste on each area to be soldered, and are subsequently heated in a furnace to melt the solder and perform bonding.

This soldering technique is generally called reflow soldering.

Various heating methods, for example infrared heating, laser heating, hot air heating, and hot plate heating, may be employed in the reflow furnace. Solder pastes must have certain rheological properties suitable for screen printing or dispensing.

### SUMMARY

A lead-free solder material is provided. The solder material may include solder particles including at least 30 wt % nickel and an activator including or consisting of at least one of a group of activator materials, the group including an organic acid or salt thereof, and an amine or salt thereof.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1A to 1D show a schematic illustration of a lead-free solder material in accordance with various embodiments;

FIG. 2 shows a schematic illustration of a layer structure in accordance with various embodiments;

FIG. 3 shows a flow diagram of a method of forming a lead-free solder material in accordance with various embodiments; and

FIG. 4 shows a flow diagram of a method of forming a layer structure in accordance with various embodiments.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various aspects of the disclosure are provided for devices, and various aspects of the disclosure are provided for methods. It will be understood that basic properties of the devices also hold for the methods and vice versa. Therefore, for sake of brevity, duplicate description of such properties may have been omitted.

The flux or vehicle of a solder paste may typically include an activator. The activator may be able to activate a passivated metal surface (e.g. the metal surfaces to be joined and/or surfaces of metal particles included in the solder material) before and/or during the soldering process. This may typically mean that the activator is able to reduce (and thereby possibly remove) oxide layers from the surfaces to be joined by the solder (the bonding surfaces) and/or from the solder powder to allow good bonding.

The flux may further include components that are configured to adjust rheological properties of the paste. Major components of conventional fluxes may be rosins and rosin derivatives at a concentration of 40 to 70 wt.%, and a combination of solvents at a concentration of 20 to 50 wt.-%, each relative to the total weight of the flux.

Solder pastes with low flux residue, so-called “no-clean solder pastes”, have been developed in the past. For example, U.S. Pat. No. 5,176,759 discloses a lead-free solder paste with minimized flux residue remaining after soldering. The solder paste includes a powdered solder and a flux in admixture.

In various embodiments, a solder material (e.g., a solder paste) is provided that includes nickel in or as solder particles, and an activator that is capable of reacting chemically with nickel oxide, e.g. of reducing the nickel oxide, during the soldering process.

The solder particles may further include tin, for example as NiSn.

The solder material may in various embodiments be free from lead. The solder particles and a solvent composition, in which the solder particles may be dispersed, may be free from lead. Hence the solder material is also referred to as “lead-free solder material”.

The nickel being part of the composition means that the selection of a suitable activator may require care, since the standard molar enthalpy of formation of nickel oxide (NiO) is Δ_{f}Hₘ⁰(298.15 K) of −240 kJ/mol, and the activator needs to be able to react exothermally with the nickel oxide at a soldering temperature.

A suitable activator may in various embodiments be found among organic acids or salts thereof, and/or among amines or salts thereof.

In various embodiments, a negative decadic logarithm of an acidity constant of the activator may be in a rage from 2<pKₐ<6.

That pKₐ may be useful for selecting suitable actviators may be plausible from the following:

A reaction taking place between an (e.g., acidic) activator and a metal oxide may be described as follows:

An acid dissociation

HA+H₂O [symbol] A⁻+H₃O⁺ (1)

may be described by an acid dissociation constant K₁.
When the activator (e.g., a flux acid) dissolves the solder oxide (the metal oxide MeO), this may be described as:

2H₃O⁺+MeO [symbol] Me²⁺+3H₂O (2)

Me²⁺+2A⁻ [symbol] MeA₂ (3)

In (3), a metal-salt with A⁻ may be formed, e.g. a metal acetate in a case where HA is acetic acid.
The acid dissociation constant K₁ may be determined as follows:

$${K}_{1} = \frac{{a}_{{H}_{3} {O}^{+}} \cdot {a}_{{A}^{-}}}{{a}_{H A} \cdot {a}_{{H}_{2} O}} = \frac{{a}_{{H}_{3} O} + {a}_{{A}^{- \cdot }}}{{a}_{H A}} ( with {a}_{{H}_{2} O} = 1 ) \qquad ( 4 )$$

A quantitative measure of a favorability of a given reaction at constant temperature and pressure is the change ΔG in Gibbs free energy that would be caused by the reaction.
For the above acid dissociation, this is referred to as ΔG_{R, 1}.

$$\begin{matrix}Δ {G}_{R , 1} = Δ {G}_{R , 1 , 0} + RT \cdot ln K 1 \\ = Δ {G}_{R , 1 , 0} + RT \cdot b \cdot log K 1 \\ = Δ {G}_{R , 1 , 0} - RT \cdot b \cdot {pK}_{a} ( with {pK}_{a} = - log {K}_{1} )\end{matrix} \\ {pK}_{a} = \frac{Δ {G}_{R , 1 , 0} - Δ {G}_{R , 1}}{b \cdot RT} \qquad ( 5 )$$

On the other hand,

ΔG_{R,1}=ΣᵢpᵢΔG_{f,i} (6)

### Combining (5) and (6):

ΔG_{f,i}˜pKₐ (7)

In the following, several chemical compounds are listed that may in various embodiments be suitable, alone or in combination, to be used as the activator.

The organic acid salt may be or include an amine salt, the amine or salt thereof may be or include an organic amine or salt thereof, for example an amine hydrohalide salt.

The activator may be or include C1-C10 monocarboxylic or dicarboxylic acids or organic diamines. The C1-C10 monocarboxylic and dicarboxylic acids may be selected from the group consisting of formic acid, acetic acid, propionic acid, butyric acid, valeric acid (pentanoic acid), caproic acid (hexanoic acid), enanthic acid (heptanoic acid), caprylic acid (octanoic acid), pelargonic acid (nonanoic acid), capric acid (decanoic acid), phenyl-acetic acid, benzoic acid, salicylic acid, aminobenzoic acid, 4-n-butylbenzoic acid, 4-t-butylbenzoic acid, 3,4-dimethoxybenzoic acid, oxalic acid, succinic acid, glutaric acid, maleic acid, fumaric acid, malic acid, adipic acid, and malonic acid. The organic diamines may be selected from the group consisting of N-alkyl-substituted and unsubstituted organic diamines. The N-alkyl-substituted and unsubstituted organic diamines may be selected from the group consisting of N,N,N′,N′-tetramethyl-1,2-ethylene diamine, N,N,N′,N′-tetraethyl-1,2-ethylene diamine, N,N,N′,N′-tetrapropyl-1,2-ethylene diamine, N-coco-1,3-diaminopropane, 1,6-diaminohexane, 1,7-diaminoheptane, 1,8-diaminooctane, 1,9-diaminononane, and 1,10-diaminodecane.

The activator may further include at least one amine selected from a group consisting of monoethanolamine, diethanolamine, triethanolamine, and isopropanolamine.

The activator may include a metal organic salt, which may optionally include nickel or tin. The metal organic salt may be an organic acid metal salt of a C1-C10 monocarboxylic or dicarboxylic acid.

The solder material, in particular the activator, may be used to reduce the contact partners, and, more generally, all surfaces included in the connection to be formed, to thereby free them from oxides. However, the majority of the surfaces to be reduced may not be coming from the contact partners, but from the high-melting fraction of the solder particles.

In various embodiments, the activator (either all the activator or just a portion of the activator) may be provided in the solder material as a coating on the solder particles. By predisposing the activation agent directly on the solder particles, requirements on the flux may be less limited, for example an amount of rosin to be included in the flux.

In other words, a high-melting fraction of the solder particles may in various embodiments be pre-treated with an agent that activates during soldering (the activator).

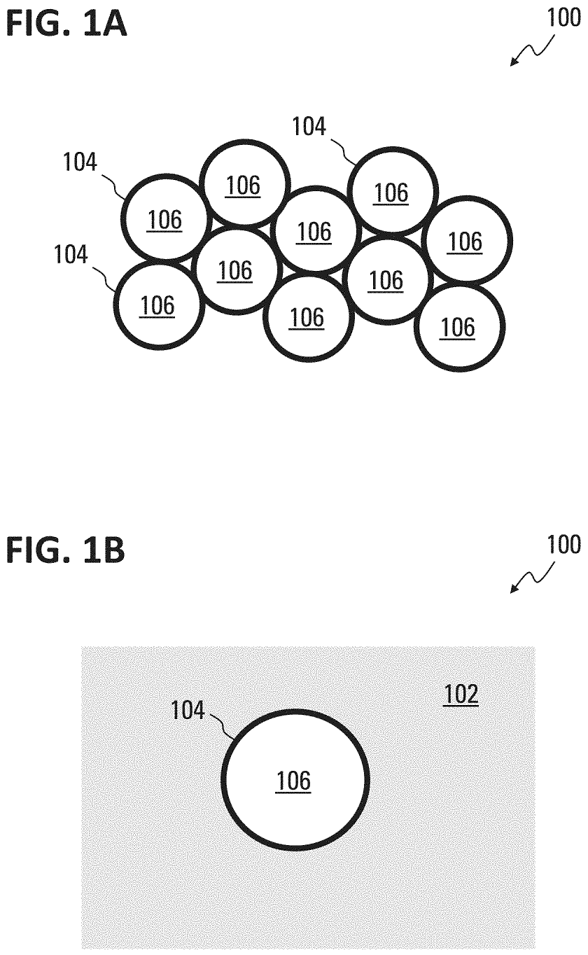

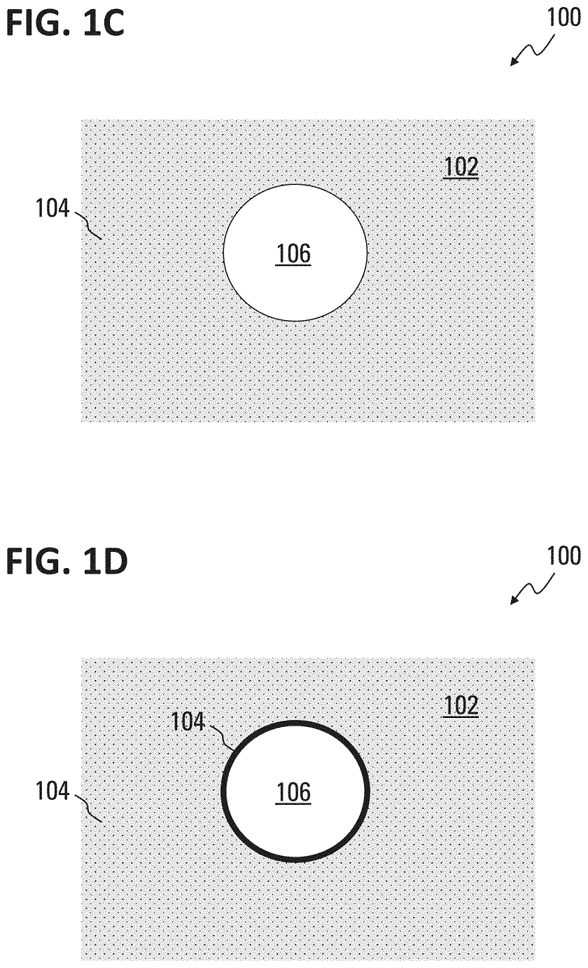

Each of FIGS. 1A, 1B, and 1D visualizes an embodiment of a solder material 100, in which the activator 104 is arranged on the solder particles 106 (in each of FIG. 1B and FIG. 1D, only one particle 106 is shown, but typically, the solder material 100 may include a plurality of solder particles 106).

In various embodiments, all the solder particles 106 may have approximately the same size. In various embodiments, the solder particles 106 may have different sizes, for example in two or more solder particle size groups.

The solder particles 106 may in various embodiments all include or consist of the same material. In various embodiments, a material or materials that the solder particles include or consist of may differ. The materials may differ in connection with the size of the solder particles 106, and/or independent from the solder particle size. For example, a first group of solder particles 106 may include or consist of a first material, and a second group of solder particles 106 may include or consist of a second material, and at least some solder particles 106 of the first group and/or of the second group may, in the embodiments with the activator 104 provided on the solder particles 106, be provided with the activator 104. In various embodiments, the first group of solder particles 106 may have a first particle size, and the second group of solder particles 106 may have a second particle size. In other embodiments, the first group of solder particles 106 may have two or more sizes, and/or the second group of solder particles 106 may have two or more sizes. It is noted that, depending on a formation and/or selection process of the solder particles 106 that are supposed to have a certain predefined size, the “particle size” is actually rather a size distribution or a range of sizes.

Providing the activator on the solder particles may cause several advantages: An amount of oxide that may form on the metal particles during the manufacturing of solder may be reduced. At least a fraction of the oxide may be replaced with the activator, for example with formate.

The particles may be shielded from further oxidation by having the activator layer (e.g., the formate layer) formed thereon, which may inhibit further oxidation during storage.

Including the activator as part of the solder particles may make it easier to provide the solder material as a (for example compacted) solder powder.

An amount of the activator forming the layer on the solder particles may be configured to provide additional reducing agent from the particles, for example during the soldering process. This means that an amount of activator that may need to be included in the solder material als part of the solvent composition may be reduced. This means that the need for (and consequently the amount of) rosin in the flux, which may also serve as an activator, may be reduced.

The activator may, for optimal effect, in various embodiments be arranged to form a layer (e.g., a distinct layer that is different from the solvent composition) that completely envelopes each of the particles. However, even a partial coverage of each of the particles, or a complete or partial coverage on just a fraction of the particles, may bring about the above advantages to a certain extent.

In various embodiments, all solder particles may be provided with the same activator. In other embodiments, different types of activator may be provided on different solder particles. In other words, a first group of particles may be provided with at least one first activator, a second group of particles may be provided with at least one second activator, etc.

In various embodiments, the lead-free solder material may further include a solvent composition, in which the solder particles may be dispersed. A weight ratio of solder particles over a sum of the solvent composition and the solder particles may in various embodiments be at least 80%.

FIG. 1B to FIG. 1D each illustrate various embodiments, in which the solder material 100 incudes a solvent composition 102. The solder particles 106 are dispersed in the solvent composition 102. In the solder material 100 of FIG. 1B, all or essentially all of the activator 104 is arranged on the solder particles 106. In FIG. 1C, all or essentially all of the activator 104 is arranged in the solvent composition 102 (for example as part of the liquid, as opposed to a layer formed on the solder particles 106). In FIG. 1D, the activator 104 is provided on the solder particles 106 and within the solvent composition 102.

The solvent composition may include at least one solvent.

As described above, the solvent composition may in various embodiments include at least a portion of the activator. In other words, in a case of the solvent composition including activator, it the solvent composition may include all the activator of the solder material, or the solvent composition may include only a portion of the activator, with the rest of the activator being, for example, deposited on the solder particles. In the case of the activator being included in the solvent composition and in or on the solder particles, the solvent composition and the solder particles may in various embodiments include the same activator or activators, for example selected from the activators described above. In various embodiments, the solvent composition and the solder particles may include different activators, for example selected from the activators described above. In various embodiments, the solvent composition and the solder particles may have at least one type of activator, for example selected from the activators described above, in common, and either the solvent composition, or the solder particles, or both may further include one or more additional activators, for example selected from the activators described above, that may not be included in the other (i.e., the solvent composition or the solder particles).

The solvent composition may in various embodiments include components that are configured to adjust rheological properties of the paste, for example a viscosity and/or a shear thinning index of the solder paste. The solder paste may in various embodiments be configured with a viscosity in a range from about 50 to about 150 Pa s as determined by a Brookfield viscosimeter at a measurement temperature in a range from about 10° C. and about 90° C., and/or with a shear thinning index of the solder paste is between about 0.3 and about 0.5. The measurement temperature (for the viscosity and the shear thinning index) may be set to a temperature at or near a dispersion temperature that is intended to be used for the applying (e.g. dispersing) of the solder paste. In present modern dispersion systems, the temperature may be selected approximately in the above cited temperature range, e.g. between about 10° C. and about 90° C.

In various embodiments, the solvent may include at least one of a group including glycol ether alcohol, 2-alkyl-1,3-hexanediol, trimethylopropane, 1,2-octanediol, 1,8-octanediol, 2,5-dimethyl-2,5-hexanediol, isobornyl cyclohexanol, mono-, di- or tri-propylene glycol methyl ether, mono-, di-, or tri-propylene glycol n-butyl ether, mono-, di-, or tri-ethylene glycol n-butyl ether, ethylene glycol methyl ether, tri-ethylene glycol methyl ether, di-ethylene glycol di-butyl ether, tetra-ethylene glycol di-methyl ether, 2-ethyl-1,3-hexanediol, n-decyl alcohol, 2-methyl-2,4-pentanediol, terpineol or alpha-Terpinol, isopropanol, and hexylene glycol.

The solvent composition may in various embodiments further include at least one rosin, for example tall oil rosin, hydrogenated rosin, partially hydrogenated rosin, dehydrogenated rosin, ethoxylated amine rosin, amine rosin, methyl ester of rosin, n-oleyl sarcosine, and/or oleyl imidazoline.

The rosin may, in various embodiments, form between 10 wt % and 25 wt % of the solvent composition.

The solvent composition may in various embodiments further include at least one thixotropic agent, for example glyceryl tris-12-hydroxy stearate, modified glyceryl tris-12-hydroxy stearate, polyamide, stearamide, and/or hydrogentated castor oil.

The thixotropic agent may, in various embodiments, form between 55 wt % and 75 wt % of the solvent composition.

The soldering temperature for which the solder material may be configured may in various embodiments be between about 200° C. and about 450° C. At the soldering temperature, at least some of the solder particles may melt, for example all the solder particles or, for example, between 20 wt % and 100 wt % of the solder particles.

Before and/or during the melting of the solder particles, the activator may reduce oxides that may be present on the solder particles (and/or elsewhere in the solder material) and/or on the surfaces to be joined by the soldering process.

In various embodiments, 99 wt % of the solvent composition may have an evaporation temperature below a soldering temperature for which the lead-free solder material is configured. In other words, about 99 wt % of the solvent composition may evaporate during the soldering process. Thus, essentially only the material provided by the solder particles may remain to form the connection between the joined surfaces, and the solvent composition may leave essentially no residue. In other words, the solder paste may be configured as a “no-clean solder paste”.

As described above, the solder material may be used for joining at least two surfaces.

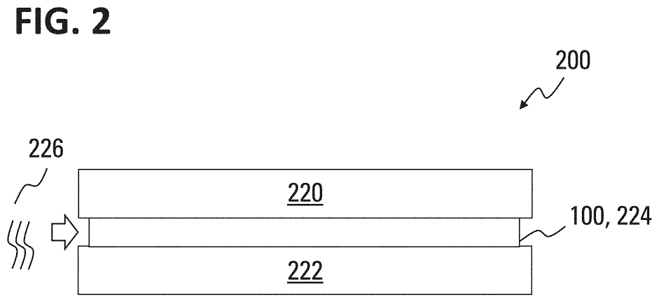

Thus, in various embodiments, a layer structure may be formed using the solder material. FIG. 2 illustrates various embodiments of such a layer structure 200.

The layer structure 200 may include a first metal layer 220, a second metal layer 222, and a solder layer 226 formed by soldering the first metal layer 220 to the second metal layer 222 using the lead-free solder material 100 as described above.

The soldering process may include heating (using a heat source 226) at least the solder material 100 to a predefined soldering temperature. Typically, at least one of the first metal layer 220 and the second metal layer 222 may be heated, too.

As described above, the soldering temperature that may be achieved using the heat source 226 may be in a range from about 200° C. to about 450° C. A predefined temperature to be achieved for the soldering process may in various embodiments lie in that range.

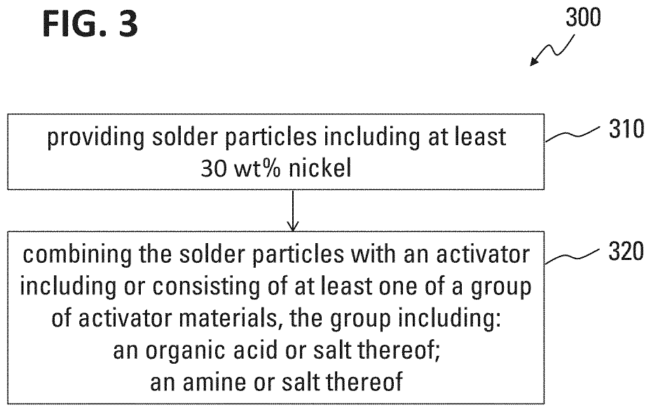

FIG. 3 shows a flow diagram 300 of a method of forming a lead-free solder material in accordance with various embodiments.

The method may include providing solder particles that include at least 30 wt % nickel (in 310), and combining the solder particles with an activator including or consisting of at least one of a group of activator materials, the group including an organic acid or salt thereof, and an amine or salt thereof (in 320).

As described above, the combining may for example include depositing the activator on the solder particles, and/or providing the activator as part of a solvent composition in which the solder particles may be dispersed.

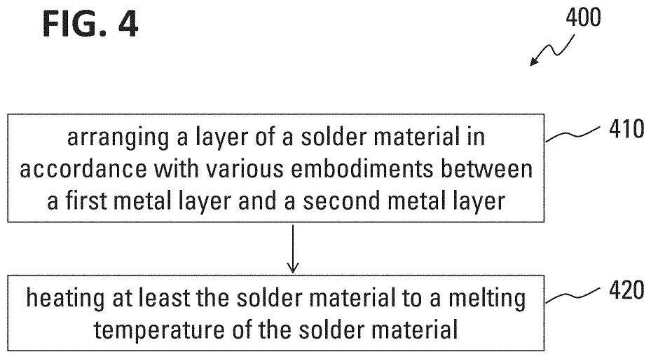

FIG. 4 shows a flow diagram 400 of a method of forming a layer structure in accordance with various embodiments.

The method may include arranging a layer of a solder material in accordance with various embodiments between a first metal layer and a second metal layer (in 410), and heating at least the solder material to a melting temperature of the solder material (in 420).

In various embodiments, the arranging of the layer of the solder material may for example include printing, arranging a paste using a mask and a squeegee, positioning a solid layer or tablet, and the like, for example as known in the art.

The heating may in various embodiments be performed essentially as known in the art, for example at soldering temperatures as described above.

Various examples will be illustrated in the following:

Example 1 is a lead-free solder material including solder particles including at least 30 wt % nickel and an activator including or consisting of at least one of a group of activator materials, the group including an organic acid or salt thereof, and an amine or salt thereof.

In Example 2, the subject-matter of Example 1 may optionally include that the organic acid salt is an amine salt.

In Example 3, the subject-matter of Example 1 or 2 may optionally include that the amine or salt thereof is an organic amine or salt thereof.

In Example 4, the subject-matter of Example 3 may optionally include that the organic amine salt is an amine hydrohalide salt.

In Example 5, the subject-matter of any of Examples 1 to 4 may optionally include that the negative decadic logarithm of an acidity constant of the activator is in a rage from 2<pKₐ<6.

In Example 6, the subject-matter of Example 1 or 2 may optionally include that the activator includes at least one of a group of activator materials, the group including: C1-C10 monocarboxylic and dicarboxylic acids and organic diamines.

In Example 7, the subject-matter of Example 6 may optionally include that the C1-C10 monocarboxylic and dicarboxylic acids are selected from the group consisting of formic acid, acetic acid, propionic acid, butyric acid, valeric acid (pentanoic acid), caproic acid (hexanoic acid), enanthic acid (heptanoic acid), caprylic acid (octanoic acid), pelargonic acid (nonanoic acid), capric acid (decanoic acid), phenyl-acetic acid, benzoic acid, salicylic acid, aminobenzoic acid, 4-n-butylbenzoic acid, 4-t-butylbenzoic acid, 3,4-dimethoxybenzoic acid, oxalic acid, succinic acid, glutaric acid, maleic acid, fumaric acid, malic acid, adipic acid, and malonic acid.

In Example 8, the subject-matter of Example 6 may optionally include that the organic diamines are selected from the group consisting of N-alkyl-substituted and unsubstituted organic diamines.

In Example 9, the subject-matter of Example 8 may optionally include that the N-alkyl-substituted and unsubstituted organic diamines are selected from the group consisting of N,N,N′,N′-tetramethyl-1,2-ethylene diamine, N,N,N′,N′-tetraethyl-1,2-ethylene diamine, N,N,N′,N′-tetrapropyl-1,2-ethylene diamine, N-coco-1,3-diaminopropane, 1,6-diaminohexane, 1,7-diaminoheptane, 1,8-diaminooctane, 1,9-diaminononane, and 1,10-diaminodecane.

In Example 10, the subject-matter of Example 9 may optionally include that the activator further includes at least one amine selected from a group consisting of monoethanolamine, diethanolamine, triethanolamine, and isopropanolamine.

In Example 11, the subject-matter of any of Examples 1 to 10 may optionally include that the activator is formed as a layer on the solder particles.

In Example 12, the subject-matter of any of Examples 1 to 11 may optionally include that the activator is formed as a layer on each of the solder particles.

In Example 13, the subject-matter of Example 12 may optionally include that the activator layer completely envelopes each of the solder particles.

In Example 14, the subject-matter of Example 12 or 13 may optionally include that the activator includes a metal organic salt.

In Example 15, the subject-matter of Example 14 may optionally include that the metal organic salt includes nickel or tin.

In Example 16, the subject-matter of Example 14 or 15 may optionally include that the metal organic salt is an organic acid metal salt of a C1-C10 monocarboxylic or dicarboxylic acid.

In Example 17, the subject-matter of any of Examples 1 to 16 may optionally further include a solvent composition, in which the solder particles are dispersed, the solvent composition including at least one solvent.

In Example 18, the subject-matter of Example 17 may optionally include that the solvent composition includes at least a portion of the activator.

In Example 19, the subject-matter of Example 17 or 18 may optionally include that the solvent includes at least one of a group including glycol ether alcohol, 2-alkyl-1,3-hexanediol, trimethylopropane, 1,2-octanediol, 1,8-octanediol, 2,5-dimethyl-2,5-hexanediol, isobornyl cyclohexanol, mono-, di- or tri-propylene glycol methyl ether, mono-, di-, or tri-propylene glycol n-butyl ether, mono-, di-, or tri-ethylene glycol n-butyl ether, ethylene glycol methyl ether, tri-ethylene glycol methyl ether, di-ethylene glycol di-butyl ether, tetra-ethylene glycol di-methyl ether, 2-ethyl-1,3-hexanediol, n-decyl alcohol, 2-methyl-2,4-pentanediol, terpineol or alpha-Terpinol, isopropanol, and hexylene glycol.

In Example 20, the subject-matter of any of Examples 17 to 19 may optionally include that the solvent composition further includes at least one rosin.

In Example 21, the subject-matter of Example 20 may optionally include that the rosin includes at least one of a group including tall oil rosin, hydrogenated rosin, partially hydrogenated rosin, dehydrogenated rosin, ethoxylated amine rosin, amine rosin, methyl ester of rosin, n-oleylsarcosine, and oleyl imidazoline.

In Example 22, the subject-matter of any of Examples 17 to 21 may optionally include that the solvent composition further includes at least one thixotropic agent.

In Example 23, the subject-matter of Example 22 may optionally include that the thixotropic agent includes at least one of a group including glyceryl tris-12-hydroxy stearate, modified glyceryl tris-12-hydroxy stearate, polyamide, stearamide, and hydrogentated castor oil.

In Example 24, the subject-matter of any of Examples 20 to 23 may optionally include that the rosin forms between 10 wt % and 25 wt % of the solvent composition.

In Example 25, the subject-matter of any of Examples 22 to 24 may optionally include that the thixotropic agent forms between 55 wt % and 75 wt % of the solvent composition.

In Example 26, the subject-matter of any of Examples 17 to 25 may optionally include that a weight ratio of solder particles over a sum of the solvent composition and the solder particles is at least 80%.

In Example 27, the subject-matter of any of Examples 1 to 26 may optionally include that the solder particles further include tin.

In Example 28, the subject-matter of any of Examples 1 to 27 may optionally be configured as a solder paste with a viscosity in a range from about 50 to about 150 Pa s as determined by a Brookfield viscosimeter at a measurement temperature between 10° C. and 90° C.

In Example 29, the subject-matter of Example 28 may optionally include that a shear thinning indexof the solder paste is between about 0.3 and about 0.5, as determined by a Brookfield viscosimeter at a measurement temperature between 10° C. and 90° C.

In Example 30, the subject-matter of any of Examples 1 to 29 may optionally be configured for a soldering temperature of between about 200° C. and about 450° C.

In Example 31, the subject-matter of any of Examples 1 to 30 may optionally include that 99 wt % of the solvent composition have an evaporation temperature below a soldering temperature for which the lead-free solder material is configured.

Example 32 is a layer structure including a first metal layer, a second metal layer, and a solder layer formed by soldering the first metal layer to the second metal layer using the lead-free solder material of any of Examples 1 to 31.

Example 33 is a method of forming a solder material. The method may include combining solder particles including at least 30 wt % nickel with an activator including or consisting of at least one of a group of activator materials, the group including an organic acid or salt thereof; and an amine or salt thereof.

In Example 34, the subject-matter of Example 33 may optionally include that the combining includes forming a layer of the activator on each of the solder particles.

In Example 35, the subject-matter of Example 33 or 34 may optionally include that the organic acid salt is an amine salt.

In Example 36, the subject-matter of any of Examples 33 to 35 may optionally include that the amine or salt thereof is an organic amine or salt thereof.

In Example 37, the subject-matter of Example 36 may optionally include that the organic amine salt is an amine hydrohalide salt.

In Example 38, the subject-matter of any of Examples 33 to 37 may optionally include that the negative decadic logarithm of an acidity constant of the activator is in a rage from 2<pKₐ<6.

In Example 39, the subject-matter of any of Examples 33 to 35 may optionally include that the activator includes at least one of a group of activator materials, the group including: C1-C10 monocarboxylic and dicarboxylic acids and organic diamines.

In Example 40, the subject-matter of Example 39 may optionally include that the C1-C10 monocarboxylic and dicarboxylic acids are selected from the group consisting of formic acid, acetic acid, propionic acid, butyric acid, valeric acid (pentanoic acid), caproic acid (hexanoic acid), enanthic acid (heptanoic acid), caprylic acid (octanoic acid), pelargonic acid (nonanoic acid), capric acid (decanoic acid), phenyl-acetic acid, benzoic acid, salicylic acid, aminobenzoic acid, 4-n-butylbenzoic acid, 4-t-butylbenzoic acid, 3,4-dimethoxybenzoic acid, oxalic acid, succinic acid, glutaric acid, maleic acid, fumaric acid, malic acid, adipic acid, and malonic acid.

In Example 41, the subject-matter of Example 39 may optionally include that the organic diamines are selected from the group consisting of N-alkyl-substituted and unsubstituted organic diamines.

In Example 42, the subject-matter of Example 41 may optionally include that the N-alkyl-substituted and unsubstituted organic diamines are selected from the group consisting of N,N,N′,N′-tetramethyl-1,2-ethylene diamine, N,N,N′,N′-tetraethyl-1,2-ethylene diamine, N,N,N′,N′-tetrapropyl-1,2-ethylene diamine, N-coco-1,3-diaminopropane, 1,6-diaminohexane, 1,7-diaminoheptane, 1,8-diaminooctane, 1,9-diaminononane, and 1,10-diaminodecane.

In Example 43, the subject-matter of Example 42 may optionally include that the activator further includes at least one amine selected from a group consisting of monoethanolamine, diethanolamine, triethanolamine, and isopropanolamine.

In Example 44, the subject-matter of any of Examples 33 to 43 may optionally include that the activator is formed as a layer that completely envelopes each of the solder particles.

In Example 45, the subject-matter of Example 44 may optionally include that the activator includes a metal organic salt.

In Example 46, the subject-matter of Example 45 may optionally include that the metal organic salt includes nickel or tin.

In Example 47, the subject-matter of Example 45 or 46 may optionally include that the metal organic salt is an organic acid metal salt of a C1-C10 monocarboxylic or dicarboxylic acid.

In Example 48, the subject-matter of any of Examples 33 to 47 may optionally further include a solvent composition, in which the solder particles are dispersed, the solvent composition including at least one solvent.

In Example 49, the subject-matter of Example 48 may optionally include that the solvent composition includes at least a portion of the activator.

In Example 50, the subject-matter of Example 48 or 49 may optionally include that the solvent includes at least one of a group including glycol ether alcohol, 2-alkyl-1,3-hexanediol, trimethylopropane, 1,2-octanediol, 1,8-octanediol, 2,5-dimethyl-2,5-hexanediol, isobornyl cyclohexanol, mono-, di- or tri-propylene glycol methyl ether, mono-, di-, or tri-propylene glycol n-butyl ether, mono-, di-, or tri-ethylene glycol n-butyl ether, ethylene glycol methyl ether, tri-ethylene glycol methyl ether, di-ethylene glycol di-butyl ether, tetra-ethylene glycol di-methyl ether, 2-ethyl-1,3-hexanediol, n-decyl alcohol, 2-methyl-2,4-pentanediol, terpineol or alpha-Terpinol, isopropanol, and hexylene glycol.

In Example 51, the subject-matter of any of Examples 48 to 50 may optionally include that the solvent composition further includes at least one rosin.

In Example 52, the subject-matter of Example 51 may optionally include that the rosin includes at least one of a group including tall oil rosin, hydrogenated rosin, partially hydrogenated rosin, dehydrogenated rosin, ethoxylated amine rosin, amine rosin, methyl ester of rosin, n-oleylsarcosine, and oleyl imidazoline.

In Example 53, the subject-matter of any of Examples 48 to 52 may optionally include that the solvent composition further includes at least one thixotropic agent.

In Example 54, the subject-matter of Example 53 may optionally include that the thixotropic agent includes at least one of a group including glyceryl tris-12-hydroxy stearate, modified glyceryl tris-12-hydroxy stearate, polyamide, stearamide, and hydrogentated castor oil.

In Example 55, the subject-matter of any of Examples 51 to 54 may optionally include that the rosin forms between 10 wt % and 25 wt % of the solvent composition.

In Example 56, the subject-matter of any of Examples 53 to 55 may optionally include that the thixotropic agent forms between 55 wt % and 75 wt % of the solvent composition.

In Example 57, the subject-matter of any of Examples 48 to 56 may optionally include that a weight ratio of solder particles over a sum of the solvent composition and the solder particles is at least 80%.

In Example 58, the subject-matter of any of Examples 33 to 57 may optionally include that the solder particles further include tin.

In Example 59, the subject-matter of any of Examples 33 to 58 may optionally be configured as a solder paste with a viscosity in a range from about 50 to about 150 Pa s, as determined by a Brookfield viscosimeter at a measurement temperature in a range from about 10° C. to about 90° C.

In Example 60, the subject-matter of Example 59 may optionally include that a shear thinning index of the solder paste is between about 0.3 and about 0.5, as determined by a Brookfield viscosimeter at a measurement temperature between 10° C. and 90° C.

In Example 61, the subject-matter of any of Examples 33 to 60 may optionally be configured for a soldering temperature of between about 200° C. and about 450° C.

In Example 62, the subject-matter of any of Examples 33 to 61 may optionally include that 99 wt % of the solvent composition have an evaporation temperature below a soldering temperature for which the lead-free solder material is configured.

Example 63 is a method of forming a layer structure. The method may include arranging a layer of a solder material in accordance with any of Examples 1 to 31 between a first metal layer and a second metal layer, and heating at least the solder material to a melting temperature of the solder material.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lead-free solder material, comprising:
solder particles comprising at least 30 wt % nickel; and
an activator comprising or consisting of at least one of a group of activator materials, the group comprising:
an organic acid or salt thereof; and
an amine or salt thereof.

2. The lead-free solder material of claim 1,
wherein the organic acid salt is an amine salt.

3. The lead-free solder material of claim 1,
wherein the amine or salt thereof is an organic amine or salt thereof.

4. The lead-free solder material of claim 3,
wherein the organic amine salt is an amine hydrohalide salt.

5. The lead-free solder material of claim 1,
wherein the negative decadic logarithm of an acidity constant of the activator is in a rage from 2<pKₐ<6.

6. The lead-free solder material of claim 1,
wherein the activator comprises at least one of a group of activator materials, the group comprising: C1-C10 monocarboxylic and dicarboxylic acids and organic diamines.

7. The lead-free solder material of claim 6, wherein
the C1-C10 monocarboxylic and dicarboxylic acids are selected from the group consisting of:
formic acid,
acetic acid,
propionic acid,
butyric acid,
valeric acid (pentanoic acid),
caproic acid (hexanoic acid),
enanthic acid (heptanoic acid)
caprylic acid (octanoic acid)
pelargonic acid (nonanoic acid)
capric acid (decanoic acid),
phenyl-acetic acid,
benzoic acid,
salicylic acid,
aminobenzoic acid,
4-n-butylbenzoic acid,
4-t-butylbenzoic acid,
3,4-dimethoxybenzoic acid,
oxalic acid,
succinic acid,
glutaric acid
maleic acid,
fumaric acid,
malic acid,
adipic acid, and
malonic acid.

8. The lead-free solder material of claim 6, wherein
the organic diamines are selected from the group consisting of N-alkyl-substituted and unsubstituted organic diamines.

9. The lead-free solder material of claim 8,
wherein the N-alkyl-substituted and unsubstituted organic diamines are selected from the group consisting of:
N,N,N′,N′-tetramethyl-1,2-ethylene diamine,
N,N,N′,N′-tetraethyl-1,2-ethylene diamine,
N,N,N′,N′-tetrapropyl-1,2-ethylene diamine,
N-coco-1,3-diaminopropane,
1,6-diaminohexane,
1,7-diaminoheptane,
1,8-diaminooctane,
1,9-diaminononane, and
1,10-diaminodecane.

10. The lead-free solder of claim 9,
wherein the activator further comprises at least one amine selected from a group consisting of
monoethanolamine,
diethanolamine,
triethanolamine, and
isopropanolamine.

11. The lead-free solder material of claim 1,
wherein the activator is formed as a layer on the solder particles.

12. The lead-free solder material of claim 1,
wherein the activator is formed as a layer on each of the solder particles.

13. The lead-free solder material of claim 12,
wherein the activator layer completely envelopes each of the solder particles.

14. The lead-free solder material of claim 11,
wherein the activator comprises a metal organic salt.

15. The lead-free solder material of claim 14,
wherein the metal organic salt comprises nickel or tin.

16. The lead-free solder material of claim 14,
wherein the metal organic salt is an organic acid metal salt of a C₁-C₁₀ monocarboxylic or dicarboxylic acid.

17. The lead-free solder material of claim 1, further comprising:
a solvent composition, in which the solder particles are dispersed, the solvent composition comprising at least one solvent.

18. The lead-free solder material of claim 17,
wherein the solvent composition comprises at least a portion of the activator.

19. The lead-free solder material of claim 17,
wherein the solvent comprises at least one of a group comprising:
glycol ether alcohol,
2-alkyl-1,3-hexanediol,
trimethylopropane,
1,2-octanediol,
1,8-octanediol,
2,5-dimethyl-2,5-hexanediol,
isobornyl cyclohexanol,
mono-, di- or tri-propylene glycol methyl ether,
mono-, di-, or tri-propylene glycol n-butyl ether,
mono-, di-, or tri-ethylene glycol n-butyl ether,
ethylene glycol methyl ether,
tri-ethylene glycol methyl ether,
di-ethylene glycol di-butyl ether,
tetra-ethylene glycol di-methyl ether,
2-ethyl-1,3-hexanediol,
n-decyl alcohol,
2-methyl-2,4-pentanediol,
terpineol or alpha-Terpinol,
isopropanol, and
hexylene glycol.

20. The lead-free solder material of claim 17,
wherein the solvent composition further comprises at least one rosin.

21. The lead-free solder material of claim 20,
wherein the rosin comprises at least one of a group comprising:
tall oil rosin,
hydrogenated rosin,
partially hydrogenated rosin,
dehydrogenated rosin,
ethoxylated amine rosin,
amine rosin,
methyl ester of rosin,
n-oleylsarcosine, and
oleyl imidazoline.

22. The lead-free solder material of claim 17,
wherein the solvent composition further comprises at least one thixotropic agent.

23. The lead-free solder material of claim 22,
wherein the thixotropic agent comprises at least one of a group comprising:
glyceryl tris-12-hydroxy stearate,
modified glyceryl tris-12-hydroxy stearate,
polyamide,
stearamide, and
hydrogentated castor oil.

24. The lead-free solder material of claim 20,
wherein the rosin forms between 10 wt % and 25 wt % of the solvent composition.

25. The lead-free solder material of claim 22,
wherein the thixotropic agent forms between 55 wt % and 75 wt % of the solvent composition.

26. The lead-free solder material of claim 17,
wherein a weight ratio of solder particles over a sum of the solvent composition and the solder particles is at least 80%.

27. The lead-free solder material of claim 1,
wherein the solder particles further comprise tin.

28. The lead-free solder material of claim 1,
configured as a solder paste with a viscosity in a range from about 50 to about 150 Pa s, as determined by a Brookfield viscosimeter at a measurement temperature between 10° C. and 90° C.

29. The lead-free solder material of claim 28,
wherein a shear thinning index of the solder paste, as determined by a Brookfield viscosimeter at a measurement temperature between 10° C. and 90° C., is between about 0.3 and about 0.5.

30. The lead-free solder material of claim 1,
configured for a soldering temperature of between about 200° C. and about 450° C.

31. The lead-free solder material of claim 1,
wherein 99 wt % of the solvent composition have an evaporation temperature below a soldering temperature for which the lead-free solder material is configured.

32. A layer structure, comprising:
a first metal layer;
a second metal layer; and
a solder layer formed by soldering the first metal layer to the second metal layer using the lead-free solder material of claim 1.

33. A method of forming a solder material, comprising:
combining solder particles comprising at least 30 wt % nickel with an activator comprising or consisting of at least one of a group of activator materials, the group comprising:
an organic acid or salt thereof;
an amine or salt thereof.

34. The method of claim 33,
wherein the combining comprises forming a layer of the activator on each of the solder particles.

35. A method of forming a layer structure, the method comprising:
arranging a layer of a solder material in accordance with claim 1 between a first metal layer and a second metal layer; and
heating at least the solder material to a melting temperature of the solder material.
